(19) United States
(12) Patent Application Publication
(10) Pub. No.: US 2004/0091690 A1
(43) Pub. Date: May 13, 2004

(54) Structural reinforcement of plastic resins using a fiber matrix

(76) Inventors: Thomas S. Moore, Oxford, MI (US); Gilbert B. Chapman II, Farmington Hills, MI (US); Del C. Schroeder, Bloomfield Hills, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/292,091

(22) Filed: Nov. 12, 2002

(51) Int. Cl. B32B 27/04

(52) U.S. Cl. 428/297.4

(57) ABSTRACT

A reinforced polymer matrix composite material with an anti-anisotropy reinforcement array is disclosed having three dimensional fiber reinforcement structures. The fiber reinforcement structures are formed of a plurality of bound or bonded fibers, which form multi-dimensional structures capable of maintaining cross structure during molding. The structures are sized to allow their use in various molding processes.

### FIELD OF THE INVENTION

This invention generally relates to reinforced polymer materials and, more particularly, to a polymer reinforcement having fiber reinforcement structures which, when used individually or in combination in a polymer matrix, provide a reinforced composite having highly robust and reliable isotropic material properties.

### BACKGROUND OF THE INVENTION

Generally, reducing mass and/or weight in the design of vehicle structural components has led to a more efficient use of engineered materials having very high stiffness properties. Various types of engineered materials have been proposed to handle this ever-increasing desire for a reduction in weight of the structural components of the vehicle. Injection-molded and compression-molded polymer composites technologies for large automotive body parts have provided processing platforms for the development of these structural components. Inherent in the large size of the automotive body parts is a requirement of high resin flow during the molding process. These high resin flows very often lead to an often unpredictable and unacceptable anisotropy within the molded components. Longer fibers tend to align with the flow of the liquid resin. This alignment provides for a molded item with varying tensile strengths and coefficients of linear thermal expansion in directions parallel and perpendicular to the fiber alignment.

The localized anisotropy, which often occurs when large parts are molded from composite materials by injection or compression molding, may lead to significant variations or deviations in localized material properties. The flow of the resin, or matrix material during the molding process often causes alignment of reinforcement particles which often are required to have a high modulus and high aspect ratio. These reinforcement particles are incorporated in order to provide strength and modulus enhancements to a composite part. Anisotropic mechanical properties manifest themselves in performance of the parts by causing inferior strength and modulus in directions orthogonal or perpendicular to the flow-induced alignment. Anisotropic physical properties, such as coefficient of thermal expansion, manifests itself as warpage of the part, causing non-uniform shrinkage upon cooling after molding.

Flow induced anisotropy can be avoided by using reinforcements having aspect ratios approaching one, such as spheroids. This approach, however, may not provide the strength enhancement needed to meet mechanical and performance requirements of structural vehicle components. Further, it is also possible to employ the use of reinforcement particles that have physical and mechanical properties that match those of the matrix. This approach, however, provides little or no enhancement of the mechanical properties of the composite structure.

A need, therefore, exists for a reinforced composite material for very large automotive components, such as vehicle body panels, vehicle frames or truck beds, that possesses a very high stiffness and yet has sufficient fatigue strength to maintain a vehicle body component over the life span of a vehicle. A need also exists for large injection molded or compression molded vehicle body parts having close to isotropic material properties to avoid post-molding deformation during cooling and inferior structural performance during use.

### SUMMARY OF THE INVENTION

In accordance with the teachings of the present invention, a reinforced polymer material is disclosed having multi-fiber reinforcement structures. The multi-fiber structures increase the tailorability and tuneability of the stiffness and properties of the composite and allow for increases in vehicle component design flexibility by virtue of its simplicity and use of known manufacturing techniques. Also as the material allows for the formation of generally isotropic materials using standard injection and compression molding techniques, component mass can be reduced, thus increasing the fuel economy of a vehicle.

In one embodiment of the invention, a reinforced material includes a polymer matrix and a generally two dimensional fiber structure bound together in an array.

In another embodiment, fibers are coupled together in a three dimensional array to generally form a cubical structure having an aspect ratio approaching one. The fiber and fiber binding allow for the maintenance of a cross structure during an injection or compression molding process. As a mixture of the fiber structures and a liquid matrix material flow into a mold, the fiber structures tend to tumble and randomly scatter.

The use of the present invention provides a reinforced composite material with improved isotropic properties. By adjusting the volume fraction of the reinforcement, the stiffness of the reinforcement fibers, and the molecular weight of the matrix, the stiffness of the material can be significantly increased. As a result, the aforementioned disadvantages associated with currently available methods for producing larger vehicle components using engineered materials have been substantially reduced or eliminated.

Further areas of applicability of the present invention will become apparent from the detailed description provided hereinafter. It should be understood that the detailed description and specific examples, while indicating preferred embodiments of the invention, are intended for purposes of illustration only and are not intended to limited the scope of the invention.

### BRIEF DESCRIPTION OF THE DRAWINGS

The present invention will become more fully understood from the detailed description and the accompanying drawings, wherein:

FIG. 1 is a perspective view of an automotive component using the reinforced composites conforming to the teachings of the current invention;

FIG. 2 is a multidimensional fiber reinforcement structure conforming to the teachings of the current invention;

FIG. 3 is an alternate embodiment of the multidimensional reinforcement structure of FIG. 2.

### DETAILED DESCRIPTION OF THE PREFERRED EMBODIMENTS

The following description of the preferred embodiments is merely exemplary in nature and is in no way intended to limit the invention, its application, or uses. Moreover, while various specific fibers and coupled fiber reinforcement structures are disclosed, it is understood by those skilled in the art that they are merely exemplary and other specific reinforcement structures or matrices may be used.

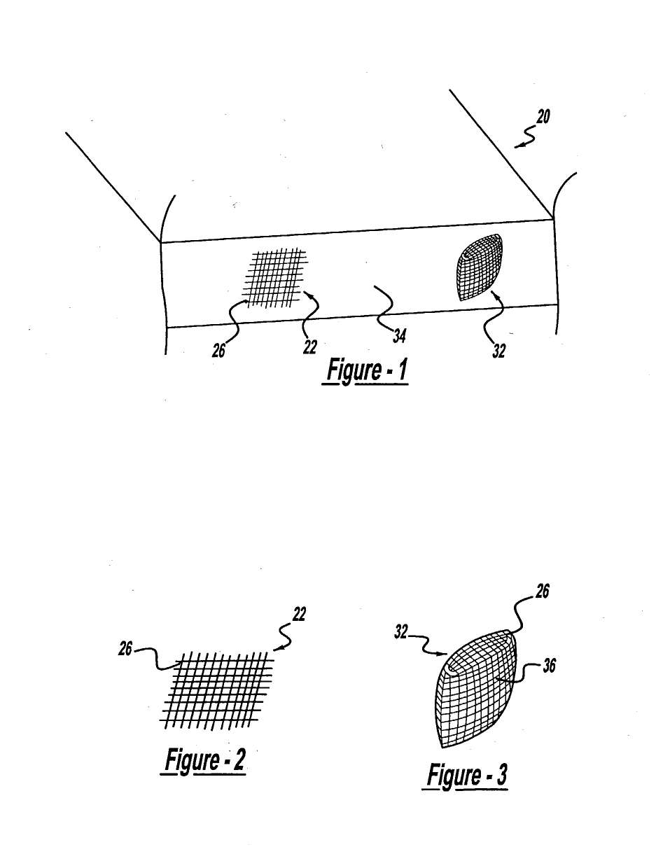

FIG. 1 represents a vehicle body component 20 formed by injection molding or compression molding technologies utilizing the fiber reinforcement structures 22, 32 of the present invention. The component is formed utilizing a large mold, which requires high flow rates. These high flow rates generally cause adverse reinforcement alignments seen in prior art systems. Only a single fiber reinforcement structure 22 and fiber reinforcement structure 32 are represented in FIG. 1. It should be noted that a typical vehicle body component 20 would incorporate thousands of fiber reinforcement structures 22 and/or 32. Fiber reinforcement structures 22, 32 are preferably oriented in a scattered array with respect to one another in order to prevent the anisotropic properties associated with aligned reinforcement structures.

The vehicle body component 20 uses the coupled fiber reinforcement structures 22 and/or 32 which incorporate high-modulus reinforcement fiber materials arranged and formed to retain a three dimensional structure during molding. These materials include, but are not limited to, steels with a tensile modulus of 30 million psi (207 GPa), aramid fibers, such as Kevlar™ with a tensile modulus of 19 million psi (124 GPa), E-glass with a tensile modulus of 10.5 million psi (72.4 GPa), aluminum with a tensile modulus of 10 million psi (70 GPa), and carbon (graphite) with a tensile modulus of 32 million to 100 million psi (222 to 690 GPa) and natural fibers.

As shown in FIG. 2, the fiber reinforcement structures 22 are composed of high aspect ratio fibers 26 which are bound in two dimensional arrays such that the height to width ratio of the array preferably approaches one. Also preferably, greater than two fibers are aligned generally parallel in a plane and orthogonal to more than two fibers that are aligned generally parallel in the same plane. It is preferred that these high modulus fibers be glass fibers with a tensile strength of 260,000 psi (1.8 GPa) and a tensile modulus of approximately 10 million psi (76 GPa) and that the fibers be five to twenty micrometers in diameter, and preferably ten micrometers in diameter. The dimensions of these structures allow for the proper flow without destruction through an injection molding machine and are restricted only by the cost and manufacturing constraints. Other fibers, materials, dimensions, and array configurations can be used for other applications. In injection molding applications, the major dimension of the coupled fiber reinforcement structures 22 must always be small enough to pass through all orifices without catastrophic deformation of the coupled fiber reinforcement structures 22. This size limit would not apply to a compression molding system.

FIG. 3 depicts a single three dimensional fiber reinforcement structure 32 conforming to the teachings of the current invention. Fiber reinforcement structure 32 has an aspect ratio of preferably less than five, and more preferably approaching one. When the fiber reinforcement structure 32 has an overall aspect ratio approaching one and having individual fibers 26 having a much higher aspect ratio, a composite formed of this material has the advantages of a composite utilizing high aspect ratio fibers without the problems of production induced anisotropy. During the molding operation, the liquid matrix material 34 and the fiber reinforcement structures 22, 32 flow together. This process allows matrix material 34 to fully contact, or wet, the fibers 26 of the fiber reinforcement structures 22, 32. As the matrix material 34 solidifies, matrix material 34 bonds to the surface of the fiber reinforcement structures 22, 32. Additionally, the cubical woven configuration of the fiber reinforcement structure 32 allows for the matrix material 34 to flow into the interstices 36 between the fibers 26 of the fiber reinforcement structure 32. The fibers 26 of the fiber reinforcement structures 22, 32 are bound by use of heat or adhesive prior to the molding. The binder can take the form of a thermoplastic coating (not shown) on the fiber 26. This coating can be melted to facilitate joining of the fibers 26.

As is known, the modulus of a composite material is a function of the volume fraction and the moduli of each component, that is the matrix and reinforcement. It is envisioned that the fiber reinforcement structures 22, 32 are disposed within matrix materials 34 such as epoxy resin, polyester resins, polyethylene terephthalate (PET), vinyl-ester resins, phenolic resins or other resins such as polyimides, bismaleimides, and polybenzimidazoles. Further, the matrix material 34 may be a form of thermoplastics such as polypropylene polycarbonates, polysulphones, polyether-ether-ketone (PEEK) and polyamides.

The description of the invention is merely exemplary in nature and, thus, variations that do not depart from the nature of the invention are intended to be within the scope of the invention. Such variations are not to be regarded as a departure from the spirit and scope of the invention.

What is claimed is:

1. A composite material comprising:
a matrix material; and
a plurality of fiber reinforcement structures formed of multiple high aspect ratio fibers, said fiber reinforcement structures dispersed throughout said matrix material, wherein the alignment of said fiber reinforcement structures is random throughout said composite material.

2. The composite material of claim 1, wherein each of said fiber reinforcement structures comprise a plurality of fibers adjoined by a binder, said fiber reinforcement structures capable of maintaining a multidimensional structure during a molding process, said binder including a resin.

3. The composite material of claim 1, wherein said fiber reinforcement structure forms a generally cubical structure.

4. The composite material of claim 3, wherein said fiber reinforcement structure has an aspect ratio of less than five.

5. The composite material of claim 3, wherein said fiber reinforcement structure has an aspect ratio of about one.

6. The composite material of claim 1, wherein said fibers are selected from a group consisting of carbon fiber, steel, aluminum, glass fiber, aramid fibers, and natural fibers.

7. The composite material of claim 1, wherein said matrix material is a thermosettable polymer.

8. The composite material of claim 7, wherein said matrix material is a selected from a group consisting of epoxy resin, polyester resins, polyethylene terephthalate, vinyl-ester resins, and phenolic resins.

9. The composite material of claim 7, wherein said matrix material is a selected from a group consisting of polyimides, bismaleimides, and polybenzimidazoles.

10. The composite material of claim 1, wherein said matrix material is a thermformable polymer.

11. The composite material of claim 10, wherein the matrix material is selected from a group consisting of polycarbonates, polysulphones, polyether-ether-ketone and polyamides.

12. The composite material of claim 1, wherein said fiber reinforcement structure has a height to width ratio of about one.

13. A fiber reinforcement structure comprising:
a plurality of fibers adjoined by a plurality of joints, said structure capable of maintaining the cross structure during a molding process.

14. The fiber reinforcement structure of claim 13, wherein said structure is generally cubical.

15. The fiber reinforcement structure of claim 13, wherein said fibers are selected from a group consisting of carbon fiber, steel, aluminum, glass fiber, aramid fibers, and natural fibers.
